(19) United States
(12) Patent Application Publication
(10) Pub. No.: US 2025/0289651 A1
(43) Pub. Date: Sep. 18, 2025

(54) CAPSULE FOR PRODUCING A BEVERAGE

(71) Applicant: SOCIETE DES PRODUITS NESTLE S.A., Vevey (CH)

(72) Inventors: VIOLETTE BOURG, Divonne Les Bains (FR); PASCAL GIRARDIN, Grandvaux (CH)

(21) Appl. No.: 18/862,714

(22) PCT Filed: May 3, 2023
(86) PCT No.: PCT/EP2023/061657

§ 371 Date: Nov. 4, 2024

(30) Foreign Application Priority Data
May 5, 2022 (EP) 22171842.2

(51) Int. Cl. B65D 85/804; A47J 31/06; B32B 1/00; B32B 5/02; B32B 7/12; B32B 29/02

(52) U.S. Cl. CPC B65D 85/8052; A47J 31/0673; B32B 1/00; B32B 5/022; B32B 7/12; B32B 29/02; B32B 2307/7163; B32B 2307/718; B32B 2307/7376; B32B 2439/70

(57) ABSTRACT

The invention concerns a capsule for use in a beverage preparation machine, said capsule containing a soluble and/or extractable beverage ingredient, said capsule comprising: -a capsule body (2) defining a chamber (21), -a top membrane (3) closing the top opening, and adapted to be punctured for liquid injection into the capsule, and a bottom membrane (4), provided inside the chamber (21) so as to delimit between the top membrane (3) and said bottom membrane an ingredient chamber, and -an opening device (5) provided inside the chamber and adapted to open the chamber by relative engagement of said opening device with the bottom membrane (4) under the effect of the liquid pressure increase in the ingredient chamber during injection of said liquid, wherein the bottom membrane is a laminated multilayer material comprising successively: -a vegetable parchment layer (41), and -an adhesive layer (42), and -a non-woven material layer (43) comprising fibres, wherein said fibres are biodegradable fibres, and wherein the vegetable parchment layer faces the opening device (5).

### FIELD OF THE INVENTION

The invention relates to a capsule for use in a beverage preparation machine.

### BACKGROUND OF THE INVENTION

Single-serve beverage capsules are known in the art. These capsules are commonly used with beverage preparation machines for on demand dispensing of beverages, like coffee or tea.

For this, usually a beverage capsule with a capsule body that encloses a beverage ingredient is inserted in a capsule receiver of a beverage preparation machine. The capsule receiver is closed and the beverage preparation is started. In the capsule receiver, a top membrane of the capsule is punctured with a needle to inject a fluid, generally water, in the capsule to interact with the beverage ingredient inside the capsule to produce the desired beverage. The fluid fills the capsule so that the pressure inside the capsule increases. When a sufficient amount of fluid fills the capsule, a self-opening mechanism in the capsule is activated and opens a bottom membrane of the capsule to release the prepared beverage at a time when the extraction of the beverage component is completed. Examples of working principles of this type of container are described in patent EP 1472156.

In the prior art, beverage containers of this type are usually made of plastic. Since these containers are designed for single time use only, their disposal has to be managed since reusing and recycling the materials used can be challenging. Therefore, attempts are made to replace these materials with alternatives, like cellulose or bioplastic, which allow overcoming the problems existing with disposing and/or recycling the containers after use. However, it has to be considered that these alternative materials do not have the same material characteristics and advantages as the usual plastic materials.

In particular, considering a capsule such as described in patent EP 1472156 and schematically illustrated in FIG. 1, such a type of capsule 1 comprises:
a capsule body 2 defining a chamber 21 with a top opening 23 closed by a top membrane 3 that is adapted to be punctured for liquid injection into the capsule, and
a bottom membrane 4, provided inside the chamber so as to delimit between the top membrane 3 and this bottom membrane 4 an ingredient chamber, and
an opening device 5 provided inside the capsule body and below the bottom membrane and adapted to open the chamber by relative engagement of said opening device with the bottom membrane under the effect of the liquid pressure increase in the ingredient chamber during injection of liquid. Usually, the opening device 5 comprises a plate 51 and this plate comprises spikes 52 with sharp pointed end rising from the upper surface 511 of the plate.

This bottom membrane is usually a film made of aluminium that can provide different properties such:
air barrier for protecting the beverage ingredient in the closed capsule before beverage preparation, and
tearing under pressure in order to dispense the prepared beverage. This tearing must happen when a certain pressure is reached inside the capsule. This tearing must not create too important holes inside the membrane in order to prevent beverage ingredient solids (coffee grounds or non-dissolved powder) from flowing downstream.

Yet, aluminium is not biodegradable and there is a need to replace aluminium by another biodegradable material when all the other parts of the capsule are biodegradable too.

In addition, a membrane in aluminium does not enable the optimal preparation of different coffee beverages such as espresso and lungo with the same capsule construction. Both types of beverages require the presence of a layer of crema at the top of the coffee beverage. During an espresso preparation, the volume of hot water introduced in the capsule is small and the opening of the aluminium membrane is obtained if the spikes of the opening device are sufficiently pointed. But during a lungo preparation, since the volume of hot water introduced in the capsule is more important, the opening of the aluminium membrane happens to early in the beverage preparation with the effect that the quantity of crema is not sufficient. To solve this problem, another type of opening device is needed for the preparation of a lungo beverage; in this opening device, the spikes of the opening device are less pointed and as, a result, the bottom aluminium membrane opens under a higher pressure creating more crema.

An object of the invention is to provide a capsule construction that can be used indifferently to prepare different types of beverages.

Another object of the invention is to provide a capsule construction that can be used indifferently to prepare lungo or espresso coffee beverages.

Another object of the invention is to provide a capsule construction that is made of compostable materials.

### SUMMARY OF THE INVENTION

In a first aspect of the invention, there is provided a capsule for use in a beverage preparation machine, said capsule containing a soluble and/or extractable beverage ingredient, and this capsule comprises:
a capsule body defining a chamber, and
a top membrane closing the top opening and adapted to be punctured for liquid injection into the capsule, and
a bottom membrane, provided inside the chamber so as to delimit between the top membrane and said bottom membrane an ingredient chamber, and
an opening device provided inside the chamber and adapted to open the chamber by relative engagement of said opening device with the bottom membrane under the effect of the liquid pressure increase in the ingredient chamber during injection of said liquid, and wherein the bottom membrane is a laminated multilayer material comprising successively:
a vegetable parchment layer, and
an adhesive layer, and
a non-woven material layer comprising fibres, wherein said fibres are biodegradable fibres, and
wherein the vegetable parchment layer faces the opening device.

This capsule comprises a capsule body defining a chamber for the beverage ingredient, a top membrane closing this chamber, a bottom membrane provided inside the chamber and an opening device adapted to open said bottom membrane.

The capsule body usually comprises:
a side wall defining a chamber and extending axially between a top opening, and
a circumferential flange projecting radially outward from the top opening, said flange comprising an upper surface opposite to the chamber with respect to the opening and an opposed lower surface.

Usually, the bottom of the capsule body comprises an outlet through which the beverage can be dispensed.

Generally, the top membrane is attached to the upper surface of the flange of the body.

The capsule comprises a beverage ingredient that can be a soluble or extractable beverage ingredient. The ingredient is hold between the top membrane and the bottom membrane.

The bottom membrane is a laminated multilayer material that can be pierced by the opening device when the pressure of water introduced through the top membrane rises in the beverage chamber.

It was observed that with the same capsule construction comprising the sane opening device and this bottom membrane, espresso and lungo beverages can be prepared with optimal quality, in particular a lungo coffee with the required layer of crema.

In addition, this membrane is advantageously compostable.

Preferably, the biodegradable fibers of the non-woven material layer are selected from the group of fibers consisting of PLA, PHA (polyhydroxyalkanoate), PHB (Poly (hydroxybutyrate)), PHB (V) (poly (hydroxybutyrate-co-hydroxyvalerate)), PBS (poly (butylenesuccinate)), biopolyesters, and cellulose fibers such as cotton, flax, wood fibers and combination thereof.

Preferably, the biodegradable fibers of the non-woven material comprises heat-sealable fibers that have a melting point of at least about 100° C.

In the preferred embodiment, the fibers of the non-woven material are composed exclusively of polylactic acid (PLA).

Preferably, the grammage of the non-woven material is between 5 and 100 g/m², advantageously between 20 and 40 g/m² and preferably on the order of 30 g/m².

Preferably the adhesive layer can be an acrylic adhesive.

Preferably, the grammage of the vegetable parchment can be between 30 and 120 g/m², advantageously between 60 and 80 g/m², and preferably on the order of 70 g/m².

Accordingly, during the beverage preparation, this grammage enables the increase of pressure inside the capsule before the bottom membrane is pierced by the opening device. Yet, this grammage enables piercing of the membrane when the pressure is sufficiently high.

Preferably, the vegetable parchment can have a thickness comprised between 60 to 150 μm.

The opening device is positioned inside the body but outside the ingredient chamber. Accordingly, the opening device is positioned below the bottom membrane.

Usually, the opening device comprises a plate and this plate comprises opening elements rising from the upper surface of the plate, and accordingly in direction of the bottom membrane. These opening elements are designed to pierce, tear, puncture the bottom membrane under the effect of the liquid pressure increase in the ingredient chamber during injection of said liquid. Preferably, these opening elements present sharp pointed end.

Preferably, the plate of the opening device comprises beverage evacuation holes extending from the upper surface of the plate to the lower surface of the plate, and these holes are positioned between the rising opening elements.

Preferably the opening device is made of a biodegradable material. This biodegradable material can be a polymeric composition, that comprises at least one polymer selected from the group consisting of polyhydroxyalkanoates (PHA).

Preferably, the capsule body is made of biodegradable or compostable materials, such as polylactic acid (PLA), polyhydroxyalcanoates (PHA), polybutylene succinate (PBS), polybutylene succinate adipate (PBSA), and/or polybutylene adipate terepthalate (PBAT).

Preferably, the top membrane is made of biodegradable or compostable materials, such as polylactic acid (PLA), polyhydroxyalcanoates (PHA), polybutylene succinate (PBS), polybutylene succinate adipate (PBSA), and/or polybutylene adipate terephthalate (PBAT).

The capsule can comprise a distributor wall extending through the internal cross section of the chamber to define an inferior sub-chamber for the ingredient and a superior distribution chamber for the liquid. This distributor wall comprises small holes to distribute liquid uniformly on the ingredient.

Such a distributor can be a compostable film made of cellophane and polybutylene succinate (PBS).

Preferably, the capsule comprises roast and ground coffee. The capsule can comprise between 4 g and 15 g of roast and ground coffee in order to prepare an espresso coffee or a lungo coffee.

In a second aspect, there is provided the use of a capsule such as described above to prepare an espresso coffee or a lungo coffee.

In the present application, technical requirements and procedures for determining biodegradability and compostability of a material are determined according to international standards, such as EU 13432 or US ASTM D6400. For example, one of the tests requires that—for a material to be considered “(industrially) compostable”—at least 90% of the material in question must be biologically degraded under controlled conditions in 6 months. Similar test schemes exist also for a certification to home compostability.

Thus, it is possible to dispose the entire capsule system after its use in compost piles so that earth can be supplied with nutrients once the material has completely broken down.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 shows a schematic cross-section of a capsule according to the present invention,

FIG. 2 shows a schematic cross-section of the laminated multilayer material of the bottom membrane.

### DETAILED DESCRIPTION OF EXEMPLARY EMBODIMENTS

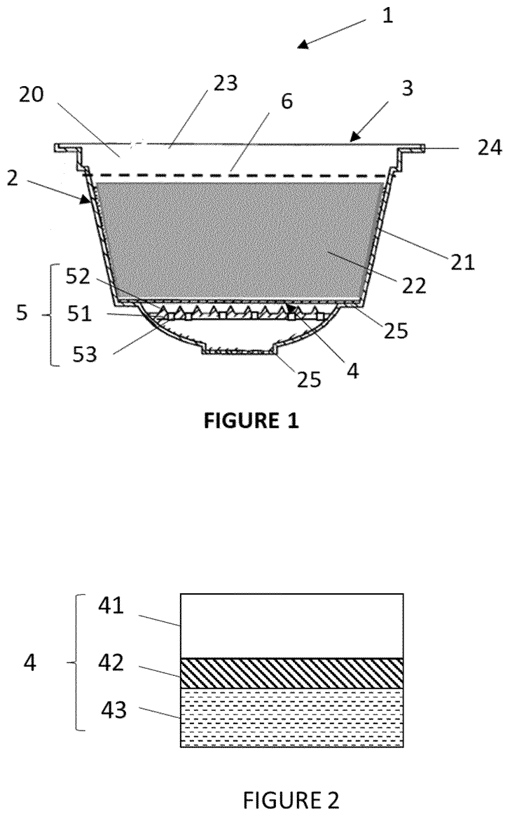

FIG. 1 illustrates schematically a capsule 1 according to the present invention.

The capsule 1 comprises a capsule body 2 with one or more sidewall(s) 21 that extend axially from a bottom towards a top. The sidewall extends towards a top opening 23. At the top opening 23, the body comprises a circumferential flange 24 that extends radially outward from the sidewall.

Generally, any transversal cross section of the body capsule is circular from the bottom to the top and the flange is circular too as illustrated in the perspective view of FIG. 2.

The sidewall delimits a chamber 22 for containing a soluble and/or extractable beverage ingredient.

This soluble beverage ingredient is a water soluble powder ingredient and can be selected within the list of: instant coffee powder, milk powder, cream powder, instant tea powder, cocoa powder, soup powder, fruit powder or mixture of said powders. The powders can be agglomerated or sintered.

This beverage ingredient packed in the package can also be an ingredient able to be extracted or infused like a roast and ground coffee, or tea leaves. In that embodiment water extracts the beverage ingredient.

The capsule comprises a top membrane 3 that is fixed, sealed or attached to at least a part of the upper surface of the circumferential flange and accordingly covers and closes the top opening 23.

This top membrane is adapted to be punctured for liquid injection into the capsule. Preferably, the top membrane is pierceable by an injection needle of the beverage preparation machine which is adapted to inject an extraction liquid under pressure inside or into the chamber. Preferably, the puncturing operation is made at one single place by a water injection needle such as described in WO2006/082064 or WO2008/107281.

The term “top membrane” should be understood as the membrane which is pierced by the injection needle of machine, as opposed to the “bottom membrane” (such as described below) which should be understood as the membrane located on the opposite side of the capsule 1.

The capsule comprises a bottom membrane 4 that closes the bottom of the chamber 22. This bottom membrane is fixed, sealed or attached to a circumferential recess 25 extending inside the internal volume of the body.

Accordingly, the soluble and/or extractable beverage ingredient is enclosed between the top and bottom membranes. The top and bottom membranes delimit an internal space of the chamber, the ingredient chamber 22, configured to hold the beverage ingredient for the preparation of a beverage.

In one embodiment, a distributor wall 6 can extend through the internal cross section of the chamber defining an inferior sub-chamber for the ingredient and a superior distribution chamber for the liquid. This distributor wall comprises small holes to distribute liquid uniformly on the ingredient.

The capsule comprises an opening device 5 adapted to open the chamber by relative engagement with the bottom membrane 4 under the effect of the liquid pressure increase in the chamber during injection of said liquid. The opening device 5 usually comprises a rigid plate 51 comprising opening elements 52 such as spikes on its surface turned upwardly towards the bottom membrane 4 which may form protrusions and recesses against the bottom membrane 4 facing the opening device.

Holes 53 can be provided in the plate 51 to dispense beverage produced in the ingredient chamber 22 to the beverage outlet 25.

Upon liquid injection inside the chamber 4, pressure builds up, which deforms the bottom membrane 4 against the opening means 5, until the bottom membrane is pierced, giving way to the beverage prepared inside the capsule 1 respectively chamber 21 below the opening device 5. The expression “engagement” may mean that, for instance, the opening device or the second membrane, or alternatively both may be moved with respect to each other to effect opening.

Usually, the capsule body comprises a bottom beverage outlet 25, below the opening device 5. The bottom of the capsule body preferably extends below the opening means to hold said opening means and collect the beverage to this beverage outlet 25 dispensing the beverage outside of the capsule 1, e.g. into a cup.

The top membrane 3 is fixed to the flange 24 in such a way that the extraction liquid injected into the chamber 21 increases internal pressure up to the pressure necessary to obtain the piercing of the deformed bottom membrane 4 by the opening device 5. The top membrane 3 is thus fixed to the flange in such a way that it does not detach at least until a defined pressure inside of the chamber is achieved. This defined pressure may be at least 2 bars, preferably at least 3 bars or at least 6 bars. Thereby, the fixation effects that the capsule 1 does not leak via the interface between the flange and the top membrane during beverage preparation.

In the state of the art, the bottom membrane 4 is made of aluminium.

In the present invention, the bottom membrane 4 is a multilayer material such as illustrated in FIG. 2.

This multilayer material 4 comprises successively:
a vegetable parchment layer 41, and
an intermediate adhesive layer 42, and
a non-woven material layer 43 comprising fibres, wherein said fibres are biodegradable fibres.

In one preferred embodiment, this multilayer material comprises:
parchment paper with a grammage of 70 gsm, and
a non-woven material comprising PLA non-woven with a grammage of 28 gsm.

In the capsule, the vegetable parchment layer 41 faces the opening device 5.

In the present invention, preferably, the opening device 5 comprises opening elements 52 that present sharp pointed ends. In addition, preferably, beverage evacuation holes 53 extend from the upper surface 511 of the plate to the lower surface 512 of the plate and are positioned between the rising opening elements 52.

When a coffee is prepared with a capsule of the state of the art comprising a bottom membrane made of aluminium and roast and ground coffee, different opening devices 5 are needed depending on the preparation of an espresso or of a lungo.

For the preparation of the espresso, the opening elements 52 of the opening device present sharp pointed ends. When water is introduced through the top membrane and the pressure increases inside the capsule, the aluminium bottom membrane is pierced and coffee dispensed under pressure. Due to the short volume of this coffee, the quantity of produced crema is adapted to this short coffee. Lungo prepared with such a capsule leads to a deceptive quantity (too low) of crema compared to the quantity of coffee; it is due to a decrease of the pressure inside the capsules once the aluminium bottom membrane is pierced by the sharp opening elements.

Then, for the preparation of the lungo, the capsule comprises more roast and ground coffee than a capsule for espresso preparation and the opening elements 52 of the opening device are configured to be less sharp (they present for example the shape of truncated cones or pyramids). When water is introduced through the top membrane and the pressure increases inside the capsule, this less sharp opening device provides a delay in the opening of the aluminium membrane compared to the espresso opening device and enables a continuous increase of the pressure inside the capsule even after the piercing of the bottom membrane. As a result, a long coffee is produced and the production of crema is obtained during a longer time providing a long coffee with a quantity of crema adapted to this long coffee.

Accordingly, the state of the art requires the provision of two different opening devices depending on the quantity and type of prepared coffee.

With a capsule according to the present invention, an espresso coffee or a lungo coffee can be prepared with the same opening device 5. The only difference between the lungo and espresso capsules relates to the quantities of roast and ground coffee hold inside the capsule.

Whatever the prepared coffee, it was observed that, after the bottom membrane is pierced by the opening device 5, the pressure goes on rising inside the capsule during a certain time. That can be explained by a swelling of the bottom membrane that absorbs water, in particular the parchment paper, and that limits the dispensing of coffee downstream the opening device. In particular, when the plate 51 of the opening device comprises beverage evacuation holes 53 extending from the upper surface 511 of the plate to the lower surface 512 of the plate, these holes can be covered by the swelled bottom membrane with the effect of limiting dispensing and maintaining pressure inside the capsule.

When a long coffee like a lungo is prepared, pressure is maintained during the beverage preparation a sufficient time to obtain enough crema in the final coffee.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

capsule 1
capsule body 2
chamber 20
sidewall 21
ingredient chamber 22
top opening 23
flange 24
bottom outlet 25
top membrane 3
bottom membrane 4
vegetable parchment layer 41
adhesive layer 42
non-woven material layer 43
opening device 5
rigid plate 51
opening elements 52
holes 53
distributor wall 6

1. A capsule for use in a beverage preparation machine, said capsule containing a soluble and/or extractable beverage ingredient,
said capsule comprising:
a capsule body defining a chamber,
a top membrane closing the top opening, and adapted to be punctured for liquid injection into the capsule, and
a bottom membrane, provided inside the chamber so as to define between the top membrane and said bottom membrane an ingredient chamber, and
an opening device provided inside the chamber and adapted to open the chamber by relative engagement of said opening device with the bottom membrane under the effect of the liquid pressure increase in the ingredient chamber during injection of said liquid,
wherein the bottom membrane is a laminated multilayer material comprising successively:
a vegetable parchment layer, and
an adhesive layer, and
a non-woven material layer comprising fibres, wherein said fibres are biodegradable fibres, and
wherein the vegetable parchment support faces the opening device.

2. The capsule according to claim 1, wherein the biodegradable fibers of the non-woven material layer are selected from the group of fibers consisting of PLA, PHA (polyhydroxyalkanoate), PHB (Poly(hydroxybutyrate)), PHB (V) (poly(hydroxybutyrate-co-hydroxyvalerate)), PBS (poly(butylenesuccinate)), biopolyesters, and cellulose fibers such as cotton, flax, wood fibers and combination thereof.

3. The capsule according to claim 1, wherein the biodegradable fibers the non-woven material comprises heat-sealable fibers that have a melting point of at least about 100° C.

4. The capsule according to claim 1, wherein the fibers of the non-woven material are composed exclusively of polylactic acid (PLA).

5. The capsule according to claim 1, wherein the grammage of the non-woven material is between 5 and 100 g/m².

6. The capsule according to claim 1, wherein the adhesive layer is an acrylic adhesive.

7. The capsule according to claim 1, wherein the grammage of the vegetable parchment is between 30 and 120 g/m².

8. The capsule according to claim 1, wherein the vegetable parchment has a thickness between 60 to 150 μm.

9. A capsule according to claim 1, wherein the capsule further comprises a capsule body made of biodegradable or compostable materials.

10. A capsule according to claim 1, wherein the capsule further comprises a top membrane made of biodegradable or compostable materials.

11. A capsule according to claim 1, wherein the ingredient chamber contains roast and ground coffee.

12. A capsule according to claim 1, wherein the opening device comprises a plate, said plate comprising opening elements rising from the upper surface of the plate, said opening elements being designed to pierce, tear, puncture the bottom membrane under the effect of the liquid pressure increase in the ingredient chamber during injection of said liquid, and wherein the opening elements present sharp pointed ends.

13. A capsule according to claim 1, wherein the plate of the opening device comprises beverage evacuation holes extending from the upper surface of the plate to the lower surface of the plate, and said holes being positioned between the rising opening elements.

14. A capsule according to claim 1, wherein said opening device is made of a biodegradable material, and said biodegradable material is a polymeric composition, said polymeric composition comprising at least one polymer selected from the group consisting of polyhydroxyalkanoates (PHA).

15. (canceled)
